(19) United States
(12) Patent Application Publication
(10) Pub. No.: US 2025/0065424 A1
(43) Pub. Date: Feb. 27, 2025

(54) POWER TOOL AND ELECTRIC CIRCULAR SAW

(71) Applicant: Nanjing Chervon Industry Co., Ltd., Nanjing (CN)

(72) Inventor: Tengyue Li, Nanjing (CN)

(21) Appl. No.: 18/764,546

(22) Filed: Jul. 5, 2024

(30) Foreign Application Priority Data
Aug. 23, 2023 (CN) 202311074029.X

(51) Int. Cl. B23D 59/00

(52) U.S. Cl. CPC B23D 59/001

(57) ABSTRACT

A power tool includes an operating member for a user to operate to select a currently adopted target working mode, where the power tool has at least two working modes; an electric motor; a drive device used for driving the electric motor; and a controller used for outputting a control signal to the drive device to control the drive device. The controller is configured to: according to the target working mode currently, determine a target switching condition for switching a control manner of the electric motor in the target working mode, where switching conditions for switching the control manner of the electric motor in different ones of the at least two working modes are different; and when the target switching condition is satisfied, switch the control manner of the electric motor from a first target control manner to a second target control manner in the target working mode.

This application claims the benefit under 35 U.S.C. § 119 (a) of Chinese Patent Application No. 202311074029.X, filed on Aug. 23, 2023, which application is incorporated herein by reference in its entirety.

### TECHNICAL FIELD

The present application relates to the technical field of power tools and, in particular, to a power tool and an electric circular saw.

### BACKGROUND

Power tools are powered by electric motors to perform a variety of operations such as cutting, grinding, and fastening. The power tools are convenient and efficient, can help operators significantly reduce labor intensity, and are widely used in construction, decoration, gardening, automobiles, and other fields. In the power tool, the electric motor that drives a functional piece to operate is generally controlled by a controller in a single control manner. However, in some scenarios, the working conditions faced by the power tool during operation are mostly complex. At this time, if the electric motor is still controlled in a single manner, the power tool cannot adapt to the changes in working conditions, causing a negative impact on the working efficiency and user experience of the power tool.

This part provides background information related to the present application, and the background information is not necessarily the existing art.

### SUMMARY

A power tool includes a functional piece; an operating member for a user to operate to select a currently adopted target working mode, where the power tool has at least two working modes; an electric motor for driving the functional piece to operate; a power supply device for supplying power to at least the electric motor; a drive device connected to the electric motor and the power supply device and used for driving the electric motor to operate; and a controller connected to the operating member and the drive device and used for outputting a control signal to the drive device to control the drive device. The controller is configured to: according to the target working mode currently adopted by the power tool, determine a target switching condition for switching a control manner of the electric motor in the target working mode, where switching conditions for switching the control manner of the electric motor in different ones of the at least two working modes are different; and in the case where the target switching condition is satisfied, switch the control manner of the electric motor from a first target control manner to a second target control manner in the target working mode.

In some examples, the controller is configured to, in the case where the target working mode is a first working mode and a first switching condition corresponding to the first working mode is satisfied, switch the control manner of the electric motor from a first control manner to a second control manner; and in the case where the target working mode is a second working mode and a second switching condition corresponding to the second working mode is satisfied, switch the control manner of the electric motor from a third control manner to a fourth control manner.

In some examples, the power tool further includes a parameter detection device connected to the controller and configured to detect one or more electric motor parameters of the electric motor and output the detected one or more electric motor parameters to the controller, where the controller is configured to use a condition in which a target electric motor parameter corresponding to the target working mode exceeds a target switching threshold corresponding to the target working mode as the target switching condition in the target working mode.

In some examples, the power tool further includes a parameter detection device connected to the controller and configured to detect multiple electric motor parameters of the electric motor and output the detected multiple electric motor parameters to the controller, where the controller is configured to use a condition in which any target electric motor parameter of multiple target electric motor parameters corresponding to the target working mode exceeds a target switching threshold corresponding to the any target electric motor parameter in the target working mode as the target switching condition in the target working mode.

In some examples, the power tool further includes a parameter detection device connected to the controller and configured to detect multiple electric motor parameters of the electric motor and output the detected multiple electric motor parameters to the controller, where the controller is configured to use a condition in which each of multiple target electric motor parameters corresponding to the target working mode exceeds a respective target switching threshold corresponding to the each of the multiple target electric motor parameters in the target working mode as the target switching condition in the target working mode.

In some examples, the electric motor parameters used as the switching conditions of the controller in different working modes are the same, and switching thresholds corresponding to the electric motor parameters are different.

In some examples, the electric motor parameters used as the switching conditions of the controller in different working modes are different, and respective switching thresholds corresponding to the electric motor parameters are different.

In some examples, the electric motor parameters include one or more of the electric motor rotational speed, the bus current, the phase current, demagnetization time, metal-oxide-semiconductor (MOS) temperature, battery pack temperature, and the battery pack voltage.

In some examples, the electric motor is a brushless motor; and the first target control manner and the second target control manner are two different control manners among a six-step commutation control manner, a field-oriented control (FOC) manner, and a sine transform control manner.

In some examples, the at least two working modes of the power tool include a wood mode and a metal mode.

In some examples, the electric motor has different rotational speeds and/or torques in different ones of the at least two working modes.

A control method for a power tool includes: according to a target working mode currently adopted by the power tool, determining, by a controller, a target switching condition for switching a control manner of the electric motor in the target working mode, where the power tool has at least two working modes; and in the case where the target switching condition is satisfied, switching, by the controller, the control manner of the electric motor from a first target control manner to a second target control manner in the target working mode.

A power tool includes a functional piece; an electric motor for driving the functional piece to operate; a power supply device for supplying power to at least the electric motor; a drive device connected to the electric motor and the power supply device and used for driving the electric motor to operate; and a controller connected to the drive device and used for outputting a control signal to the drive device to control the drive device. The controller is configured to: when the electric motor starts, assume that the power tool is currently in a first working mode, control the electric motor in a first control manner, and determine a first switching condition corresponding to the first working mode; and if the first switching condition is satisfied in the first working mode, determine that the power tool is currently in a second working mode, switch a control manner of the electric motor from the first control manner to a second control manner, and determine a second switching condition corresponding to the second working mode, where the second switching condition is different from the first switching condition.

An electric circular saw includes a saw blade; an electric motor for driving the saw blade to operate; a power supply device for supplying power to at least the electric motor; a drive device connected to the electric motor and the power supply device and used for driving the electric motor to operate; and a controller connected to the drive device and used for outputting a control signal to the drive device to control the drive device. The controller is configured to: when the electric motor starts, assume that the electric circular saw is currently in a first working mode, control the electric motor in a first control manner, and determine a first switching condition corresponding to the first working mode; and if the first switching condition is satisfied in the first working mode, determine that the electric circular saw is currently in a second working mode, switch a control manner of the electric motor from the first control manner to a second control manner, and determine a second switching condition corresponding to the second working mode, where the second switching condition is different from the first switching condition.

In some examples, the controller is configured to, if the second switching condition is satisfied in the second working mode, determine that the electric circular saw is currently in the first working mode and switch the control manner of the electric motor from the second control manner to the first control manner.

In some examples, the power tool further includes a parameter detection device connected to the electric motor and the controller and configured to detect multiple electric motor parameters of the electric motor and output the detected multiple electric motor parameters to the controller, where the multiple electric motor parameters used in the first switching condition and the multiple electric motor parameters used in the second switching condition are at least partially different.

In some examples, the first control manner is a six-step commutation control manner, and the second control manner is an FOC manner.

In some examples, the multiple electric motor parameters used in the first switching condition include a control signal duty cycle of the electric motor, and the multiple electric motor parameters used in the second switching condition include the bus current of the electric motor and/or the electric motor rotational speed.

### BRIEF DESCRIPTION OF THE DRAWINGS

FIG. 1 is a perspective view of a power tool as an example of the present application.

FIG. 2 is an electrical control schematic diagram of a controller, a drive device, and an electric motor in the power tool shown in FIG. 1.

FIG. 3 is an electrical control schematic diagram illustrating that a controller in the power tool shown in FIG. 1 drives an electric motor in a six-step commutation control manner.

FIG. 4 is an electrical control schematic diagram illustrating that a controller in the power tool shown in FIG. 1 drives an electric motor in an FOC manner.

FIG. 5 is a flowchart illustrating that the controller shown in FIG. 2 switches electric motor control manners.

FIG. 6 is another flowchart illustrating that the controller shown in FIG. 2 switches electric motor control manners.

FIG. 7 is another flowchart illustrating that the controller shown in FIG. 2 switches electric motor control manners.

FIG. 8 is another flowchart illustrating that the controller shown in FIG. 2 switches electric motor control manners.

FIG. 9 is another flowchart illustrating that the controller shown in FIG. 2 switches electric motor control manners.

FIG. 10 is a perspective view of an electric drill as an example of the present application.

FIG. 11 is a perspective view of an electric wrench as an example of the present application.

FIG. 12 is a perspective view of a jigsaw as an example of the present application.

FIG. 13 is a flowchart of a control method for a power tool as an example of the present application.

FIG. 14 is a perspective view of an electric circular saw as an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

Technical solutions proposed in the present application are described in detail in conjunction with drawings and examples.

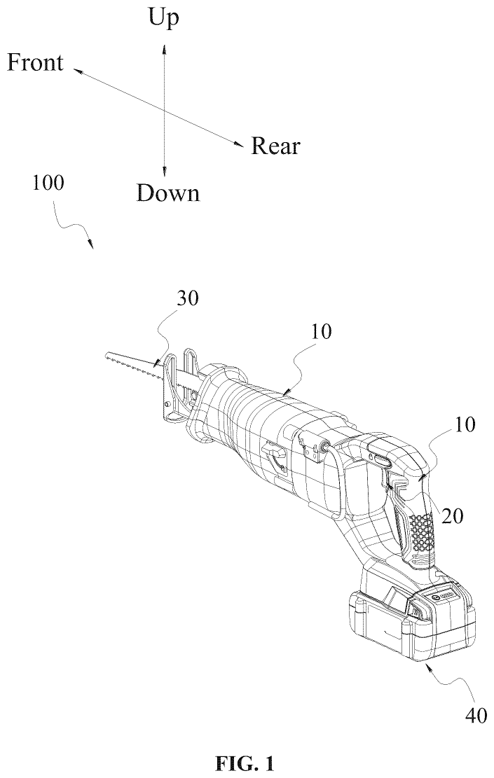

FIG. 1 shows a power tool 100 as an example of the present application. The power tool 100 shown in FIG. 1 may be a reciprocating saw 100a. The power tool 100 in another example may be another type of handheld power tool 100b such as an electric drill, an electric circular saw, or an impact wrench, or a table tool 100c such as a miter saw or a table saw, or a self-propelled garden tool 100d such as a mower. It is to be understood that the power tool is not limited to the categories described above. As long as the power tool is operated through a motor-driven functional piece and has at least two working modes, the technical solutions proposed in the present application are applicable to the power tool, for example, a blender.

The power tool 100 in the present application has at least two working modes. Different working modes may be artificially set and distinguished. For example, two different working modes may be a first working mode belonging to user A and adapted to the usage habits of user A and a second working mode belonging to user B and adapted to the usage habits of user B. Different working modes may be set and distinguished based on the differences in relevant physical properties. For example, considering different characteristics of the electric motor such as the rotational speed and torque when facing different materials to be cut, a sawing tool may be configured to have a wood mode and a metal mode. Alternatively, the power tool 100 may simply be configured to have a low-speed high-torque mode, a high-speed low-torque mode, or the like.

Referring to FIG. 1, the power tool 100 includes a housing 10, an operating member 20, a functional piece 30, and a power supply device 40. The housing 10 forms the body of the power tool 100, is connected to or supports the operating member 20, the functional piece 30, and the power supply device 40, and forms an accommodation space. An electric motor 50 as well as a drive device 60 and a controller 70 to be described later are accommodated in the accommodation space of the housing 10. The operating member 20 is operable by the user to start or stop the power tool 100 and select the working mode of the power tool 100 described above. The working mode selected by the user operating the operating member 20 is a target working mode currently adopted by the power tool 100 and is one of multiple working modes of the power tool 100. The operating member 20 is structurally connected to the housing 10 and may be a mechanical switch, a signal switch, or the like. In some examples, after being operated by the user, the operating member 20 may transmit a mode signal corresponding to the target working mode selected by the user to the controller 70 to be described later so that the controller 70 can identify the target working mode currently adopted by the power tool 100.

The functional piece 30 is the actual working part of the power tool 100, may be a cutting part such as a saw blade, may be a fastener, a grinding part, an impact part, or the like, and is structurally connected to an output shaft of the power tool 100. When the shaft of the electric motor 50 rotates, the shaft of the electric motor 50 can drive the output shaft directly or indirectly through a transmission assembly to rotate to drive the functional piece 30 connected to the output shaft to complete cutting, fastening, grinding, and other related operations. The power supply device 40 supplies electrical energy to at least the electric motor 50 to be described later to drive the electric motor 50 to operate. Of course, the power supply device 40 may supply electrical energy to the drive device 60 and the controller 70. In some examples, the power supply device 40 may be a battery pack detachably connected to the housing 10. In other examples, the power tool 100 may be powered by mains power or the alternating current (AC) power supply in conjunction with a power adapter or related circuits such as the transformer circuit, the rectifier circuit, and the voltage regulator circuit.

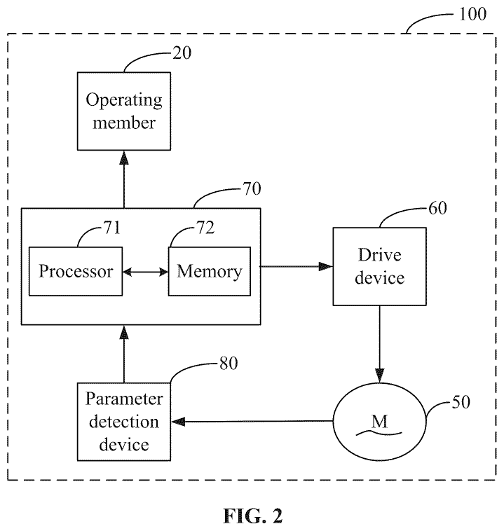

Referring to FIG. 2, the power tool 100 further includes the electric motor 50, the drive device 60, and the controller 70. The electric motor 50 is the prime mover in the power tool 100 that provides power for the operation of the functional piece 30. The specific operation process of the electric motor 50 is controlled by the controller 70. The electric motor 50 is electrically connected to the drive device 60 and the controller 70 so that a control signal from the controller 70 is transmitted to the electric motor 50 through the drive device 60, thereby driving the electric motor 50 to operate. The control signal outputted by the controller 70 corresponds to the control manner adopted by the controller 70. In the present application, the controller 70 has at least two control manners for driving the electric motor 50. In some cases, the specific control manner adopted by the controller 70 is related to the presence or absence of a position sensor for positioning the rotor position of the electric motor 50 in the power tool 100.

In some examples, the electric motor 50 is a brushless motor 50. Specifically, the electric motor 50 may be a three-phase brushless direct current (DC) electric motor 50, and the control manners include, but are not limited to, a six-step commutation control manner, an FOC manner, and a sine transform control manner. The drive device 60 may include a driver circuit such as a three-phase bridge inverter. In some cases, the drive device 60 may be an integrated driver chip. The driver circuit with a three-phase bridge inverter as the core is used as an example. The drive device 60 may receive six control signals from the controller 70 and output corresponding three-phase signals to the electric motor 50. The three-phase signals are sine wave signals of the same frequency and equal amplitude at a phase angle of 120° to each other.

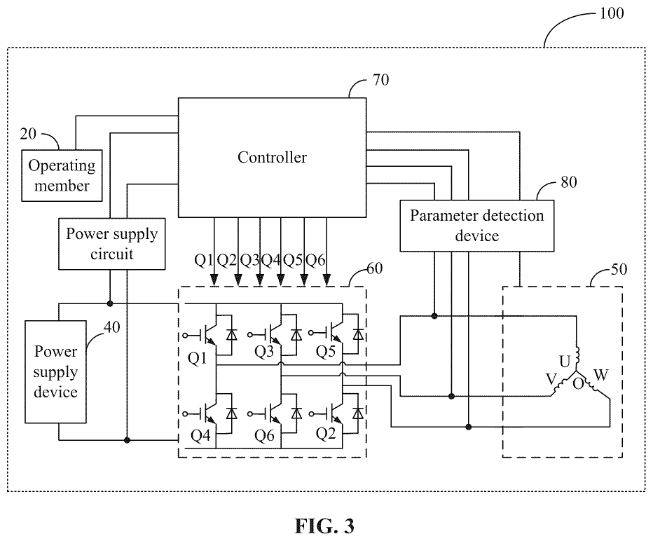

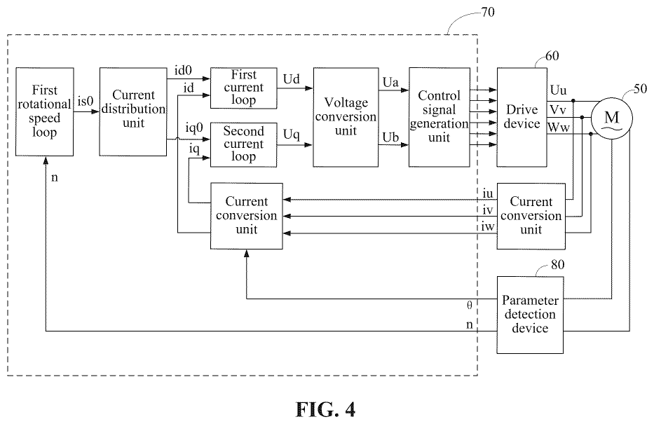

For example, as shown in FIG. 3, the controller 70 in the power tool 100 may adopt the six-step commutation control manner to control the electric motor 50. The controller 70 may output six control signals to the drive device 60. In the six-step commutation manner, the control signals outputted by the controller 70 are square wave signals or trapezoidal wave signals. The controller 70 may be connected to two switching transistor elements in the three-phase bridge inverter in sequence so that the drive device 60 finally outputs approximate three-phase signals. The six-step commutation control manner has the advantages of convenience, easy control, and low heat consumption. For example, as shown in FIG. 4, the controller 70 in the power tool 100 may adopt the FOC (also known as vector control) manner to control the electric motor 50. The controller 70 may still output six control signals to the drive device 60. In the FOC manner, the control signals outputted by the controller 70 are sine wave signals. In the FOC manner, the drive device 60 may output more accurate three-phase signals. The FOC manner has the advantages of precision, high efficiency, and high torque. It is to be understood that depending on the application scenarios of the power tool 100 and the requirements of specific working conditions, the control manner of the electric motor 50 may further include other control manners not described above.

The controller 70 includes a processor 71 and a memory 72. The processor 71 may be a microcontroller unit (MCU), an advanced reduced instruction set computer machine (ARM), a digital signal processor (DSP), or the like, and the memory 72 may be a read-only memory (ROM), a random-access memory (RAM), an erasable programmable read-only memory (EPROM) or a flash memory, a combination thereof, or the like. The memory 72 stores control programs executable by the processor 71. The processor 71 can read and run the control programs in the memory 72 to control the electric motor 50.

The controller 70 is electrically connected to the drive device 60 and can output the control signal corresponding to the current control manner to the drive device 60 after running the control programs. The controller 70 may be electrically connected to the operating member 20 to determine, by receiving the mode signal from the operating member 20, the target working mode currently adopted by the power tool 100.

To ensure that the power tool 100 always adopts a suitable control manner to control the electric motor 50 so that the electric motor 50 can satisfy the mode requirements and operate efficiently in different working modes and different working conditions, the controller 70 determines the target working mode currently adopted by the power tool 100 before controlling the electric motor 50 to start operating. In some cases, by receiving the mode signal from the operating member 20, the controller 70 determines the target working mode selected by the user. In other cases, the target working mode currently adopted by the power tool 100 is detected and switched by the controller 70 so that the controller 70 can determine the current target working mode directly or indirectly through relevant parameters.

After the target working mode is determined, according to the target working mode, the controller 70 determines a first target control manner and a second target control manner that can be adopted when controlling the electric motor 50 in the target working mode and a target switching condition for switching the control manner of the electric motor 50 in the target working mode. In some examples, the controller 70 may run the same set of control programs to control the electric motor 50. The controller 70 queries the corresponding target switching condition, the first target control manner, and the second target control manner according to the target working mode and changes the switching condition currently adopted in the control programs to the target switching condition when running the control programs. Depending on whether the switching condition is satisfied, the first target control manner or the second target control manner is adopted. The memory 72 may store the mapping relationship between the working modes, the switching conditions, and the control manners. The switching conditions corresponding to different working modes are different, or both the switching conditions and control manners corresponding to different working modes are different. In other examples, the controller 70 runs different control programs in different working modes to control the electric motor 50. According to the target working mode, the controller 70 calls the corresponding control programs. The switching conditions in the control programs corresponding to different working modes are different, or both the switching conditions and control manners in the control programs corresponding to different working modes are different.

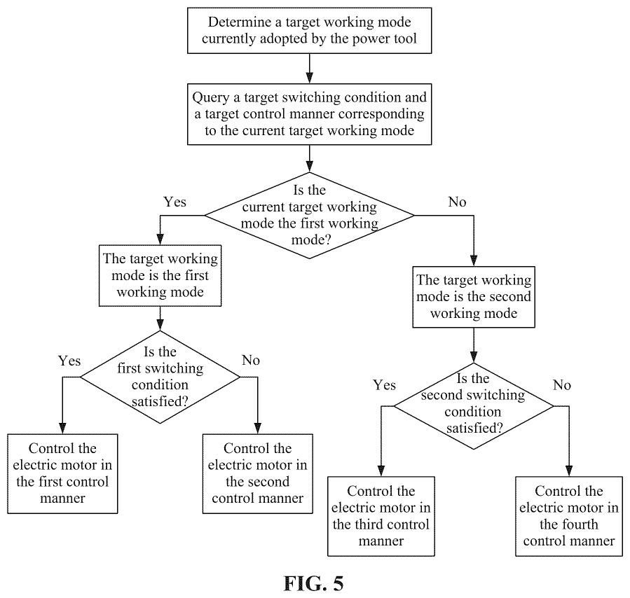

When the target switching condition is satisfied, the controller 70 switches the control manner of the electric motor 50 from the first target control manner to the second target control manner in the target working mode. In other words, in the case where the target switching condition is not satisfied, the controller 70 adopts the first target control manner in the target working mode to control the electric motor 50; and in the case where the target switching condition is satisfied, the controller 70 adopts the second target control manner in the target working mode to control the electric motor 50. Specifically, as shown in FIG. 5, assuming that the power tool 100 has the first working mode and the second working mode, in the case where the controller 70 determines that the working mode currently adopted by the power tool 100 is the first working mode, if the first switching condition corresponding to the first working mode is not satisfied, the electric motor 50 is controlled in a first control manner; and if the first switching condition is satisfied, the electric motor 50 is controlled in a second control manner. In the case where the controller 70 determines that the working mode currently adopted by the power tool 100 is the second working mode, if the second switching condition corresponding to the second working mode is not satisfied, the electric motor 50 is controlled in a third control manner; and if the second switching condition is satisfied, the electric motor 50 is controlled in the fourth control manner. The first switching condition is different from the second switching condition, the first control manner is different from the second control manner, and the third control manner is different from the fourth control manner. However, there is no specific limitation to whether the first control manner is the same as the third control manner or the fourth control manner and whether the second control manner is the same as the third control manner or the fourth control manner. In addition, the power tool 100 may have more working modes, the example in which the controller 70 controls the electric motor 50 in more working modes may be derived based on the preceding description, and the details are not repeated here.

In some examples, the power tool 100 further includes a parameter detection device 80. The parameter detection device 80 is electrically connected to the electric motor 50 and the controller 70 and can detect electric motor parameters such as voltage, current, power, rotational speed, and torque of the electric motor 50 and transmit the detected electric motor parameters to the controller 70. In different examples, the types and numbers of electric motor parameters detected and transmitted by the parameter detection device 80 may be the same or different. In some examples, the parameter detection device 80 may detect only one or more electric motor parameters corresponding to the target working mode currently adopted by the power tool 100.

In the controller 70, the electric motor parameter and the corresponding switching threshold may be used for representing the switching condition for switching the control manner of the electric motor 50. When the electric motor parameter exceeds the corresponding switching threshold, the switching condition is deemed to be satisfied. A mapping relationship exists between the working modes, the electric motor parameters, the switching thresholds, and the control manners in the controller 70. The electric motor parameters and/or switching thresholds corresponding to different working modes are different, the switching thresholds corresponding to different electric motor parameters are different, and the control manners corresponding to different working modes may be the same or different. The electric motor parameters used as the switching conditions include, but are not limited to, the bus current, the phase current, the electric motor rotational speed, the demagnetization time, and the MOS temperature of the electric motor 50, as well as the battery pack temperature, the battery pack voltage, and other relevant parameters related to the battery pack information of a battery pack 40. It is to be understood that, depending on different types of power tools and the change in actual scenario requirements, the electric motor parameters used as the switching conditions may further include other types of electric motor parameters not shown.

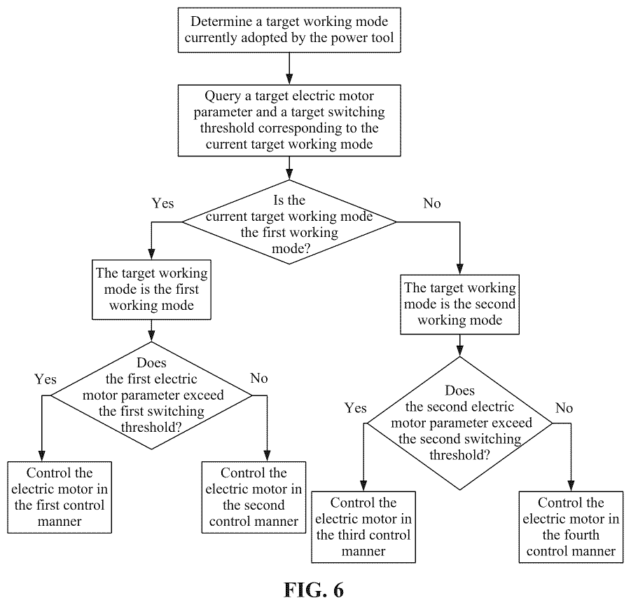

In some examples, as shown in FIG. 6, in the controller 70, a single electric motor parameter and the corresponding switching threshold may be used for representing the switching condition. According to the target working mode currently adopted by the power tool 100, the controller 70 may determine a target electric motor parameter corresponding to the target working mode and a target switching threshold corresponding to the target electric motor parameter in the current target working mode. When the target electric motor parameter currently detected and transmitted by the parameter detection device 80 does not exceed the preset target switching threshold corresponding to the target electric motor parameter, the controller 70 may adopt the first target control manner in the target working mode to control the electric motor 50. When the target electric motor parameter exceeds the preset target switching threshold corresponding to the target electric motor parameter, the controller 70 may adopt the second target control manner in the target working mode to control the electric motor 50.

In one case, the types of electric motor parameters used as the switching conditions in different working modes are the same, but the values of the switching thresholds corresponding to the electric motor parameters used as the switching conditions in different working modes are different. For example, the bus current (the electric motor parameter) may be used as the switching condition in different working modes, but the bus current has different values when the control manner is switched in different working modes. In another case, the types of electric motor parameters used as the switching conditions in different working modes are different, and the switching thresholds corresponding to the electric motor parameters used as the switching conditions in different working modes are also different. For example, the bus current may be used as the switching condition in the first working mode, and the rotational speed of the electric motor 50 may be used as the switching condition in the second working mode. Naturally, the bus current value when the control manner is switched in the first working mode is different from the rotational speed value of the electric motor 50 when the control manner is switched in the second working mode.

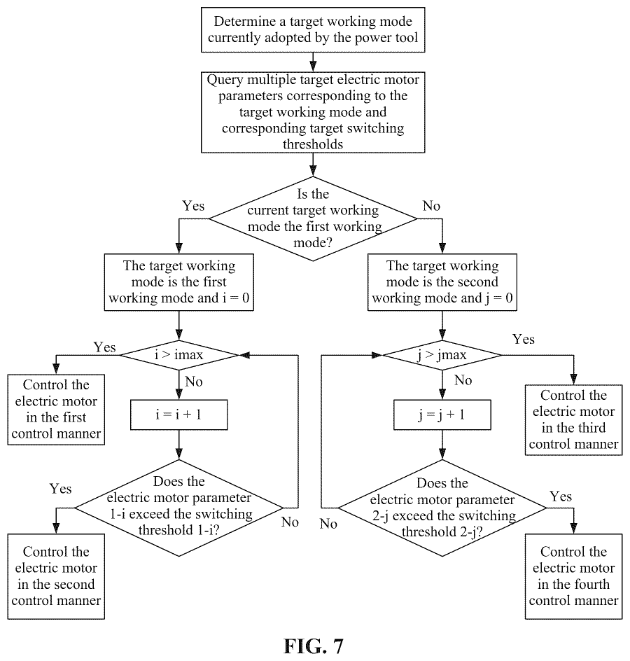

In some examples, as shown in FIG. 7, in the controller 70, multiple electric motor parameters and the corresponding switching thresholds may be used for representing the switching condition. According to the target working mode currently adopted by the power tool 100, the controller 70 may determine one or more target electric motor parameters corresponding to the target working mode and target switching thresholds corresponding to the target electric motor parameters in the current target working mode. When all the multiple target electric motor parameters currently detected by the parameter detection device 80 do not exceed the preset target switching thresholds corresponding to the multiple target electric motor parameters, the controller 70 may adopt the first target control manner in the target working mode to control the electric motor 50. When any target electric motor parameter of the multiple target electric motor parameters exceeds the preset target switching threshold corresponding to the any target electric motor parameter, the controller 70 may adopt the second target control manner in the target working mode to control the electric motor 50.

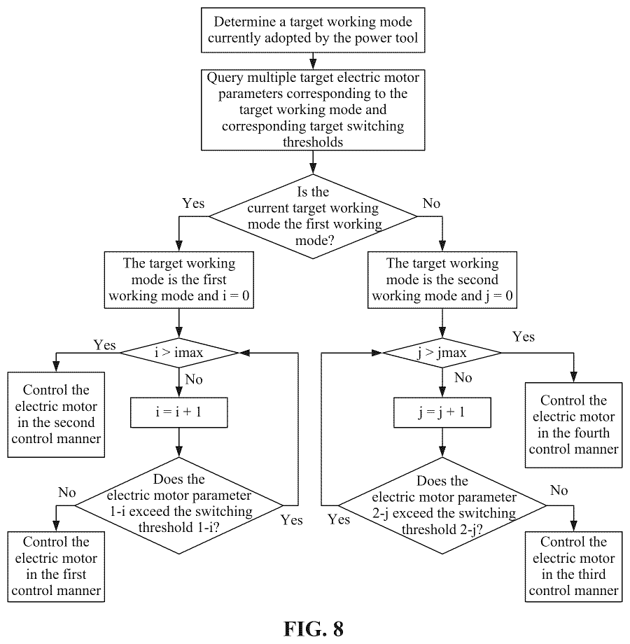

In other examples, as shown in FIG. 8, when a target electric motor parameter among the multiple target electric motor parameters currently detected by the parameter detection device 80 does not exceed the preset target switching threshold corresponding to the any target electric motor parameter, the controller 70 may adopt the first target control manner to control the electric motor 50; and when all the multiple target electric motor parameters exceed the preset target switching thresholds corresponding to the multiple target electric motor parameters, the controller 70 may adopt the second target control manner to control the electric motor 50.

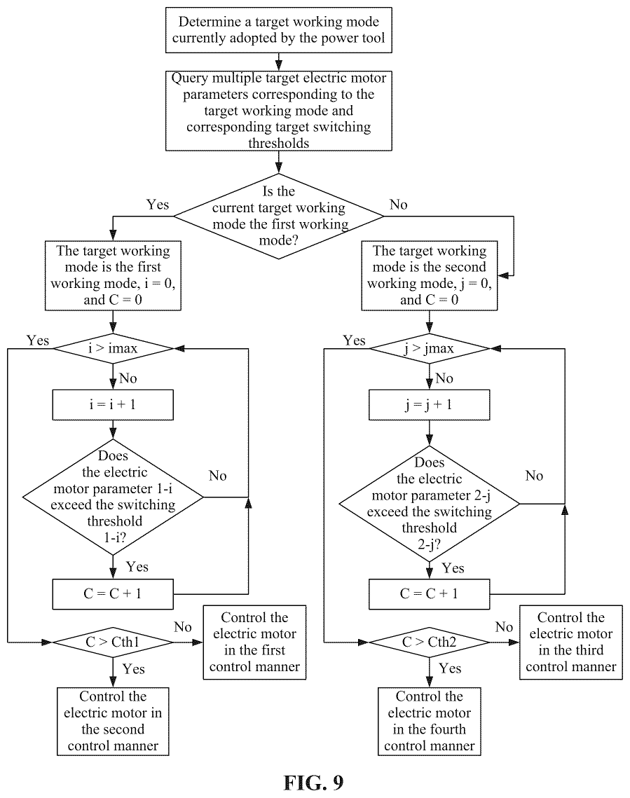

In other examples, as shown in FIG. 9, when the number of target electric motor parameters exceeding the preset corresponding target switching thresholds among the multiple target electric motor parameters currently detected by the parameter detection device 80 does not exceed a number threshold, the controller 70 may adopt the first target control manner to control the electric motor 50; and when the number of target electric motor parameters exceeding the preset corresponding target switching thresholds among the multiple target electric motor parameters exceeds the number threshold, the controller 70 may adopt the second target control manner to control the electric motor 50.

In one case, the types of the multiple electric motor parameters used as the switching conditions in different working modes are the same, but at least one of the values of the switching thresholds corresponding to the multiple electric motor parameters used as the switching conditions in different working modes is different. In another case, the types and/or numbers of electric motor parameters used as the switching conditions in different working modes are different, the switching thresholds corresponding to different types of electric motor parameters are different whether in the same working mode or different working modes, and the switching thresholds corresponding to the same type of electric motor parameters in different working modes may be the same or different.

It is to be understood that the controller 70 may determine which control manner should be adopted to control the electric motor 50 at the current moment based on multiple target electric motor parameters and other more complex preset rules. For example, the controller 70 may calculate multiple target electric motor parameters based on a preset function and compare the multiple target electric motor parameters with a preset calculation threshold to determine which electric motor control manner to adopt, where the calculation thresholds in different working modes may be different, or both the calculation functions and calculation thresholds in different working modes may be different.

In the power tool described above, according to the working mode currently adopted by the power tool, the controller determines the switching condition of the electric motor control manner corresponding to the working mode. The controller not only switches the control manner of the electric motor based on whether the switching condition is satisfied but also switches the control manner of the electric motor based on different switching conditions in different working modes. In this manner, when the power tool operates in different working conditions and different working modes, the power tool can drive the electric motor to operate in the control manners suitable for the characteristics of the working conditions and working modes, thereby effectively improving the efficiency of the electric motor and the tool and improving the user experience.

To clarify the technical solutions proposed in the present application, the reciprocating saw 100a is described below.

The reciprocating saw 100a shown in FIG. 1 is used as an example. The reciprocating saw 100a has two working modes, that is, the wood mode and the metal mode. The reciprocating saw 100a adopts the wood mode when cutting wood, and the electric motor 50 is required to have a high rotational speed and a strong anti-locked-rotor capability. The reciprocating saw 100a adopts the metal mode when cutting metal, and the electric motor 50 is required to have a stable and relatively low rotational speed and relatively large torque. The user may operate the operating member 20 connected to the housing 10 of the reciprocating saw 100a to select one of the preceding two working modes.

TABLE 1

| | | | Switching condition | | |
|---|---|---|---|---|---|
| | Target | Target | Electric | | |
| Working | control | control | motor | Switching | |
| mode | manner 1 | manner 2 | parameter | threshold | |
| Wood mode | FOC | Six-step | Bus | 60 | A |
| | | commutation | current | | |
| Metal mode | FOC | Six-step | Electric | 1800 | RPM |

| | |
|---|---|
| commutation | motor |
| | rotational |
| | speed |

When the controller 70 in the reciprocating saw 100a receives the mode signal from the operating member 20 and determines that the current working mode is the wood mode, Table 1 may be queried to determine whether to switch between the FOC manner and the six-step commutation control manner based on whether the bus current exceeds 60 A in the wood mode. When it is detected that the current bus current of the electric motor 50 is 15 A, it indicates that the electric motor 50 is currently in a light load state, and the controller 70 adopts the FOC manner to control the electric motor 50 to increase the rotational speed of the electric motor 50. When it is detected that the bus current is 65 A, it indicates that the electric motor 50 is currently in a heavy load state, and the controller 70 adopts the six-step commutation control manner to control the electric motor 50 to reduce the locked rotor current and improve the anti-locked-rotor capability.

When the controller 70 in the reciprocating saw 100a determines that the current working mode is the metal mode, Table 1 may be queried to determine whether to switch between the FOC manner and the six-step commutation control manner based on whether the electric motor rotational speed exceeds 1800 RPM in the metal mode. When it is detected that the current rotational speed of the electric motor 50 is 1500 RPM, it indicates that the electric motor 50 is currently in a low speed state, and the controller 70 adopts the FOC manner to control the electric motor 50 to increase the torque. When it is detected that the electric motor rotational speed is 2200 RPM, it indicates that the electric motor 50 is currently in a high speed state, and the controller 70 adopts the six-step commutation control manner to control the electric motor 50 to reduce heat generation.

Further, an electric drill 100b is described below.

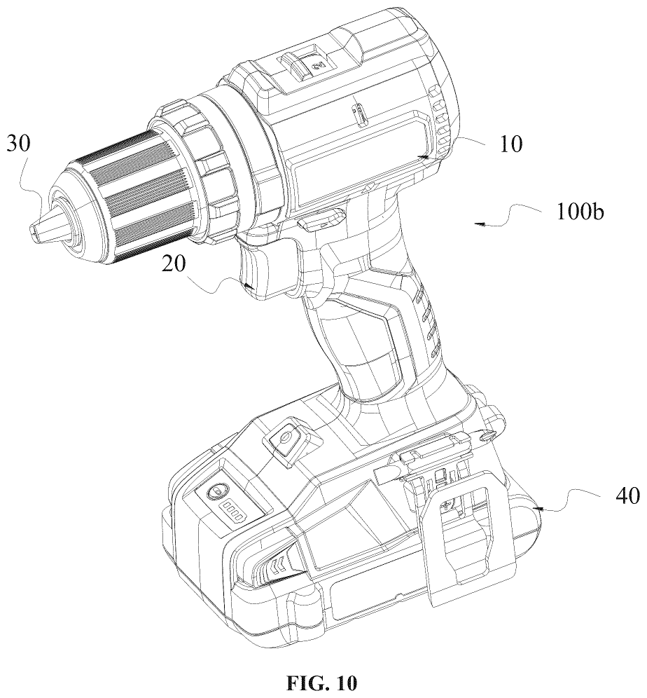

Referring to the electric drill 100b shown in FIG. 10, the electric drill 100b has a screw mode and a steel plate drilling mode. The electric drill 100b adopts the screw mode when loosening and tightening screws, while the electric drill 100b adopts the steel plate drilling mode when drilling holes in metal sheets. The user may operate the operating member 20 connected to the housing 10 of the electric drill 100b to select one of the preceding two working modes.

TABLE 2

| | | | Switching condition | | |
|---|---|---|---|---|---|
| | Target | Target | Electric | | |
| Working | control | control | motor | Switching | |
| mode | manner 1 | manner 2 | parameter | threshold | |
| Screw mode | FOC | Six-step | Bus current | 40 | A |
| | | commutation | | | |
| Steel plate | FOC | Six-step | Electric | 25000 | RPM |

| | | |
|---|---|---|
| drilling | commutation | motor |
| mode | | rotational |
| | | speed |

When the controller 70 in the electric drill 100b receives the mode signal from the operating member 20 and determines that the current working mode is the screw mode, Table 2 may be queried to determine whether to switch between the FOC manner and the six-step commutation control manner based on whether the bus current exceeds 40 A in the screw mode. When it is detected that the current bus current of the electric motor 50 is 30 A, the controller 70 controls the electric motor 50 in the FOC manner; and when it is detected that the bus current is 45 A, the controller 70 controls the electric motor 50 in the six-step commutation control manner.

When the controller 70 in the electric drill 100b determines that the current working mode is the steel plate drilling mode, Table 2 may be queried to determine whether to switch between the FOC manner and the six-step commutation control manner based on whether the electric motor rotational speed exceeds 25000 RPM in the steel plate drilling mode. When it is detected that the current rotational speed of the electric motor 50 is 18000 RPM, the controller 70 controls the electric motor 50 in the FOC manner; and when it is detected that the electric motor rotational speed is 28000 RPM, the controller 70 controls the electric motor 50 in the six-step commutation control manner.

Further, an electric wrench 100c is described below.

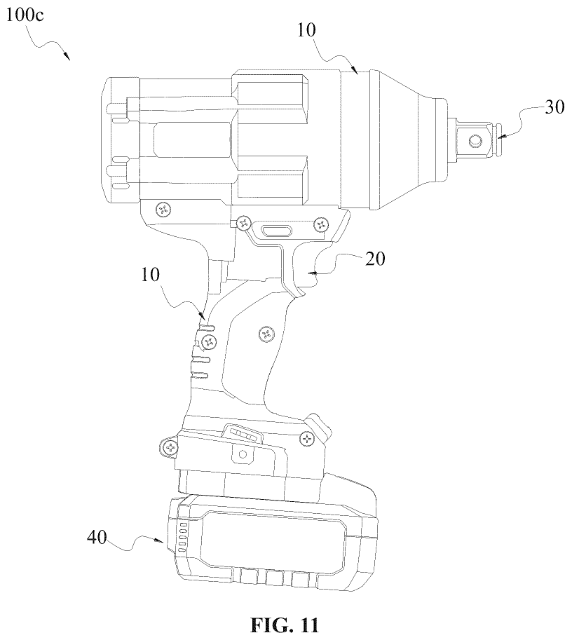

The electric wrench 100c shown in FIG. 11 is used as an example. The electric wrench 100c has two working modes: a tightening mode and a loosening mode. The electric wrench 100c adopts the tightening mode when tightening a workpiece, while the electric wrench 100c adopts the loosening mode when loosening a workpiece. The user may operate the operating member 20 connected to the housing 10 of the electric wrench 100c to select one of the preceding two working modes.

TABLE 3

| | | | Switching condition | | |
|---|---|---|---|---|---|
| | Target | Target | Electric | | |
| Working | control | control | motor | Switching | |
| mode | manner 1 | manner 2 | parameter | threshold | |
| Tightening | Six-step | FOC | Bus current | 20 | A |
| mode | commutation | | | | |
| Loosening | FOC | Six-step | Electric | 28000 | RPM |

| | | |
|---|---|---|
| mode | commutation | motor |
| | | rotational |
| | | speed |

When the controller 70 in the electric wrench 100c receives the mode signal from the operating member 20 and determines that the current working mode is the tightening mode, Table 3 may be queried to determine whether to switch between the FOC manner and the six-step commutation control manner based on whether the bus current exceeds 20 A in the tightening mode. When it is detected that the current bus current of the electric motor 50 is 15 A, the controller 70 controls the electric motor 50 in the FOC manner; and when it is detected that the bus current is 25 A, the controller 70 controls the electric motor 50 in the six-step commutation control manner.

When the controller 70 in the electric wrench 100c determines that the current working mode is the loosening mode, Table 3 may be queried to determine whether to switch between the FOC manner and the six-step commutation control manner based on whether the electric motor rotational speed exceeds 28000 RPM in the loosening mode. When it is detected that the current rotational speed of the electric motor 50 is 18000 RPM, the controller 70 controls the electric motor 50 in the FOC manner; and when it is detected that the electric motor rotational speed is 30000 RPM, the controller 70 controls the electric motor 50 in the six-step commutation control manner.

Further, a jigsaw 100d is described below.

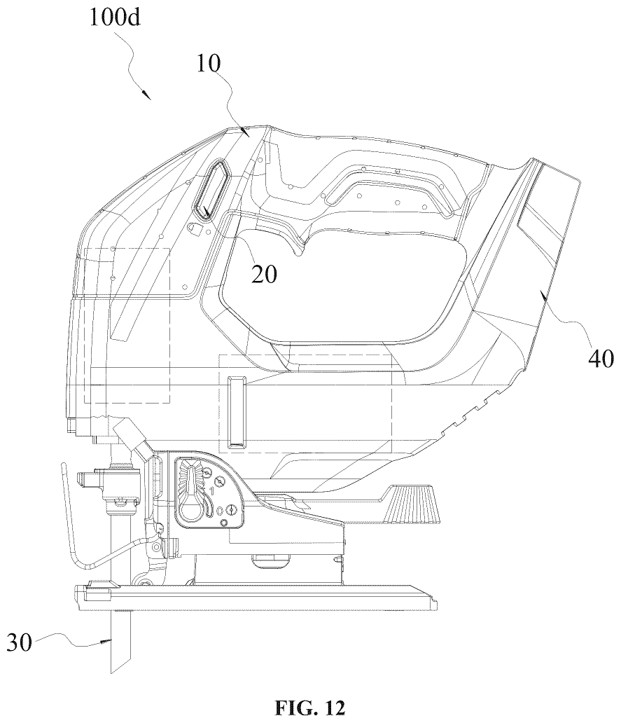

The jigsaw 100d shown in FIG. 12 is used as an example. The jigsaw 100d has six working modes from the first gear to the sixth gear. When the jigsaw 100d adopts the first gear, the electric motor 50 is required to have a stable and relatively low rotational speed, relatively large torque, and less heat generation. When the jigsaw 100d adopts the sixth gear, the electric motor 50 is required to have a high rotational speed and a strong anti-locked-rotor capability. In addition, the service life of the tool needs to be extended when the power is relatively low. The user may operate the operating member 20 connected to the housing 10 of the jigsaw 100d to select any of the preceding gears.

TABLE 4

| | | | Switching condition | |
|---|---|---|---|---|
| | Target | Target | Electric | |
| Working | control | control | motor | Switching |
| mode | manner 1 | manner 2 | parameter | threshold |
| First gear | FOC | Six-step | Bus current | 60 A |
| mode | | commutation | | |
| Sixth gear | FOC | Six-step | Electric | 2000 RPM & 17 V |
| mode | | commutation | motor | |
| | | | rotational | |
| | | | speed & | |
| | | | Battery | |
| | | | pack | |
| | | | voltage | |

When the controller 70 in the jigsaw 100d receives the mode signal from the operating member 20 and determines that the current working mode is the first gear, Table 4 may be queried to determine whether to switch between the FOC manner and the six-step commutation control manner based on whether the bus current exceeds 60 A in the first gear mode. When it is detected that the current bus current of the electric motor 50 is 35 A, the controller 70 controls the electric motor 50 in the FOC manner; and when it is detected that the bus current is 75 A, the controller 70 controls the electric motor 50 in the six-step commutation control manner.

When the controller 70 in the jigsaw 100d determines that the current working mode is the sixth gear, Table 4 may be queried to determine whether to switch between the FOC manner and the six-step commutation control manner based on whether the electric motor rotational speed exceeds 2000 RPM and whether the battery pack voltage exceeds 17 V in the sixth gear mode. When it is detected that the current rotational speed of the electric motor 50 is 1500 RPM and the battery pack voltage is 15 V, the controller 70 controls the electric motor 50 in the FOC manner; when it is detected that the electric motor rotational speed is 2050 RPM and the battery pack voltage is 16.8 V, the controller 70 controls the electric motor 50 in the FOC manner; and when it is detected that the electric motor rotational speed is 2200 RPM and the battery pack voltage is 18 V, the controller 70 controls the electric motor 50 in the six-step commutation control manner.

In some examples, the target working mode of the preceding power tool may be switched automatically so that the user does not need to operate the preceding operating member to select the mode. Specifically, the working mode of the power tool may be switched depending on the duration after the electric motor starts. For example, within 30 seconds after the electric motor is started, the working mode of the power tool is the first working mode, and after 30 seconds of the electric motor being started, the working mode of the power tool is the first working mode. That is, a preset time point is used as the switching point for switching the working mode. Alternatively, the working mode of the power tool may be switched depending on the electric motor control manner. For example, after the electric motor starts, the power tool is in the first working mode by default and the electric motor is controlled in the first control manner by default. In the first working mode and the first control manner, the first control manner is switched to the second control manner based on the first switching condition. After the first switching condition is satisfied, the electric motor is controlled in the second control manner and the second working mode. In the second working mode and the second control manner, the second control manner is switched to the first control manner based on the second switching condition. After the second switching condition is satisfied, the electric motor is controlled in the first control manner and the first working mode.

In some examples, when the electric motor 50 starts, assuming that the power tool 100 is currently in the first working mode, the controller 70 controls the electric motor 50 in the first control manner and determines the first switching condition for changing the first control manner in the first working mode. If the first switching condition is satisfied in the first working mode, the current working mode of the power tool 100 is switched to the second working mode, the control manner of the electric motor 50 is switched from the first control manner to the second control manner, and the second switching condition for changing the second control manner in the second working mode is determined. The first switching condition is different from the second switching condition. For example, the types of electric motor parameters used in the first switching condition and the second switching condition are at least partially different. In some examples, if the second switching condition is satisfied in the second working mode, the current working mode of the power tool 100 may be switched back to the first working mode, and the control manner of the electric motor 50 may be switched from the second control manner back to the first control manner. Alternatively, if the second switching condition is satisfied in the second working mode, the working mode of the power tool 100 may be switched to a third working mode, and the control manner of the electric motor 50 may be switched from the second control manner to the third control manner.

An electric circular saw is described below. Referring to an electric circular saw 100e shown in FIG. 14, when the electric motor of the electric circular saw starts, assuming that the electric circular saw is in the first working mode, the controller controls the electric motor in the six-step commutation control manner. At the same time, the duty cycle of a pulse-width modulation (PWM) signal driving the electric motor is used as the switching condition, and a duty cycle threshold is set. When the duty cycle in the first working mode exceeds the duty cycle threshold, the controller controls the electric motor in the FOC manner in the second working mode. At the same time, the bus current and/or electric motor rotational speed are used as the switching condition, and a bus current threshold, an electric motor rotational speed threshold, or calculation thresholds of the bus current and the electric motor rotational speed are set. When the bus current and/or the electric motor rotational speed in the second working mode exceed the corresponding thresholds, the controller controls the electric motor in the six-step commutation control manner in the first working mode.

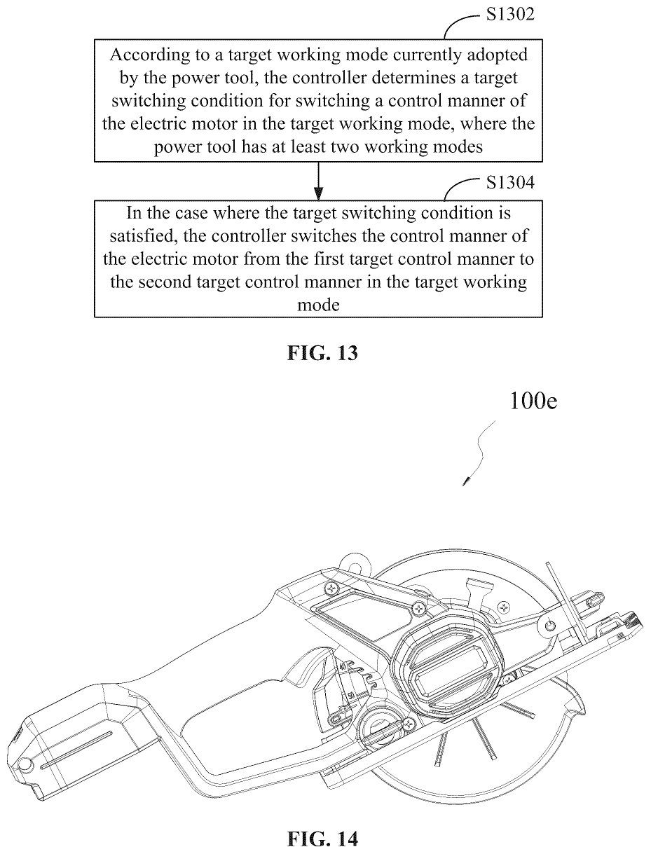

Correspondingly, FIG. 13 is a flowchart of a control method for a power tool as an example of the present application. The control method for a power tool shown in FIG. 13 is applicable to any power tool 100 described above, and the control method includes the steps below.

In S1302, according to a target working mode currently adopted by the power tool 100, the controller 70 determines a target switching condition for switching a control manner of the electric motor 50 in the target working mode, where the power tool 100 has at least two working modes.

In 1304, in the case where the target switching condition is satisfied, the controller 70 switches the control manner of the electric motor 50 from the first target control manner to the second target control manner in the target working mode.

In some examples, in the case where the target working mode is a first working mode and a first switching condition corresponding to the first working mode is satisfied, the controller 70 switches the control manner of the electric motor 50 from a first control manner to a second control manner; and in the case where the target working mode is a second working mode and a second switching condition corresponding to the second working mode is satisfied, the controller 70 switches the control manner of the electric motor 50 from a third control manner to a fourth control manner.

In some examples, the parameter detection device 80 detects one or more electric motor parameters of the electric motor 50 and outputs the detected one or more electric motor parameters to the controller 70, where the controller 70 uses a condition in which a target electric motor parameter corresponding to the target working mode exceeds a target switching threshold corresponding to the target working mode as the target switching condition in the target working mode.

In some examples, the controller 70 uses a condition in which any target electric motor parameter of multiple target electric motor parameters corresponding to the target working mode exceeds a target switching threshold corresponding to the any target electric motor parameter in the target working mode as the target switching condition in the target working mode.

In some examples, the controller 70 uses a condition in which each of multiple target electric motor parameters corresponding to the target working mode exceeds a respective target switching threshold corresponding to the each of the multiple target electric motor parameters in the target working mode as the target switching condition in the target working mode.

In some examples, the electric motor parameters used as the switching conditions of the controller 70 in different working modes are the same, and switching thresholds corresponding to the electric motor parameters are different.

In some examples, the electric motor parameters used as the switching conditions of the controller 70 in different working modes are different, and respective switching thresholds corresponding to the electric motor parameters are different.

In some examples, the electric motor parameters include one or more of the electric motor rotational speed, the bus current, demagnetization time, MOS temperature, battery pack temperature, and the battery pack voltage.

In some examples, the electric motor 50 is a brushless motor; and the first target control manner and the second target control manner are two different control manners among a six-step commutation control manner, a field-oriented control (FOC) manner, and a sine transform control manner.

In some examples, the working modes of the power tool 100 include a wood mode and a metal mode.

In some examples, the electric motor 50 has different rotational speeds and/or torques in different working modes.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application

What is claimed is:

1. A power tool, comprising:
a functional piece;
an operating member for a user to operate to select a currently adopted target working mode, wherein the power tool has at least two working modes, and the currently adopted target working mode is one of the at least two working modes;
an electric motor for driving the functional piece to operate;
a power supply device for supplying power to at least the electric motor;
a drive device connected to the electric motor and the power supply device and used for driving the electric motor to operate; and
a controller, connected to the operating member and the drive device, used for outputting a control signal to the drive device to control the drive device and configured to:
according to the currently adopted target working mode currently adopted by the power tool, determine a target switching condition for switching a control manner of the electric motor in the currently adopted target working mode, wherein switching conditions for switching the control manner of the electric motor in different ones of the at least two working modes are different; and
in a case where the target switching condition is satisfied, switch the control manner of the electric motor from a first target control manner to a second target control manner in the currently adopted target working mode.

2. The power tool of claim 1, wherein the controller is configured to, in a case where the currently adopted target working mode is a first working mode and a first switching condition corresponding to the first working mode is satisfied, switch the control manner of the electric motor from a first control manner to a second control manner; and in a case where the currently adopted target working mode is a second working mode and a second switching condition corresponding to the second working mode is satisfied, switch the control manner of the electric motor from a third control manner to a fourth control manner.

3. The power tool of claim 1, further comprising a parameter detection device connected to the electric motor and the controller and configured to detect one or more electric motor parameters of the electric motor and output the one or more electric motor parameters to the controller, wherein the controller is configured to use a condition in which a target electric motor parameter corresponding to the currently adopted target working mode exceeds a target switching threshold corresponding to the currently adopted target working mode as the target switching condition in the currently adopted target working mode.

4. The power tool of claim 1, further comprising a parameter detection device connected to the electric motor and the controller and configured to detect a plurality of electric motor parameters of the electric motor and output the plurality of electric motor parameters to the controller, wherein the controller is configured to use a condition in which a target electric motor parameter of a plurality of target electric motor parameters corresponding to the currently adopted target working mode exceeds a target switching threshold corresponding to the target electric motor parameter in the currently adopted target working mode as the target switching condition in the currently adopted target working mode.

5. The power tool of claim 1, further comprising a parameter detection device connected to the electric motor and the controller and configured to detect a plurality of electric motor parameters of the electric motor and output the plurality of electric motor parameters to the controller, wherein the controller is configured to use a condition in which each of a plurality of target electric motor parameters corresponding to the currently adopted target working mode exceeds a respective target switching threshold corresponding to the each of the plurality of target electric motor parameters in the currently adopted target working mode as the target switching condition in the currently adopted target working mode.

6. The power tool of claim 1, further comprising a parameter detection device connected to the electric motor and the controller and configured to detect a plurality of electric motor parameters of the electric motor and output the plurality of electric motor parameters to the controller, wherein the controller is configured to use a condition in which calculation values of one or more target electric motor parameters corresponding to the currently adopted target working mode exceed target switching thresholds corresponding to the one or more target electric motor parameters in the currently adopted target working mode as the target switching condition in the currently adopted target working mode.

7. The power tool of claim 3, wherein the electric motor parameters used as the switching conditions of the controller in different working modes are the same, and switching thresholds corresponding to the electric motor parameters are different.

8. The power tool of claim 3, wherein the electric motor parameters used as the switching conditions of the controller in different working modes are different.

9. The power tool of claim 3, wherein the electric motor parameters comprise one or more of an electric motor rotational speed, a control signal duty cycle, a bus current, a phase current, demagnetization time, metal-oxide semiconductor (MOS) temperature, battery pack temperature, and a battery pack voltage.

10. The power tool of claim 1, wherein the electric motor is a brushless motor, and the first target control manner and the second target control manner are two different control manners among a six-step commutation control manner, a field-oriented control (FOC) manner, and a sine transform control manner.

11. The power tool of claim 1, wherein the at least two working modes of the power tool comprise a wood mode and a metal mode.

12. The power tool of claim 1, wherein the at least two working modes of the power tool comprise any pair of a screw mode and a steel plate drilling mode, a tightening mode and a loosening mode, and a first gear mode and an n-th gear mode.

13. The power tool of claim 1, wherein the electric motor has different rotational speeds and/or torques in different ones of the at least two working modes.

14. The power tool of claim 1, wherein the power tool is a reciprocating saw, an electric drill, an electric wrench, a jigsaw, or an electric circular saw.

15. A power tool, comprising:
a functional piece;
an electric motor for driving the functional piece to operate;
a power supply device for supplying power to at least the electric motor;
a drive device connected to the electric motor and the power supply device and used for driving the electric motor to operate; and
a controller, connected to the drive device, used for outputting a control signal to the drive device to control the drive device and configured to:
when the electric motor starts, assume that the power tool is currently in a first working mode, control the electric motor in a first control manner, and determine a first switching condition corresponding to the first working mode; and
when the first switching condition is satisfied in the first working mode, determine that the power tool is currently in a second working mode, switch a control manner of the electric motor from the first control manner to a second control manner, and determine a second switching condition corresponding to the second working mode, wherein the second switching condition is different from the first switching condition.

16. An electric circular saw, comprising:
a saw blade;
an electric motor for driving the saw blade to operate;
a power supply device for supplying power to at least the electric motor;
a drive device connected to the electric motor and the power supply device and used for driving the electric motor to operate; and
a controller, connected to the drive device, used for outputting a control signal to the drive device to control the drive device and configured to:
when the electric motor starts, assume that the electric circular saw is currently in a first working mode, control the electric motor in a first control manner, and determine a first switching condition corresponding to the first working mode; and
when the first switching condition is satisfied in the first working mode, determine that the electric circular saw is currently in a second working mode, switch a control manner of the electric motor from the first control manner to a second control manner, and determine a second switching condition corresponding to the second working mode, wherein the second switching condition is different from the first switching condition.

17. The electric circular saw of claim 16, wherein the controller is configured to, when the second switching condition is satisfied in the second working mode, determine that the electric circular saw is currently in the second working mode and switch the control manner of the electric motor from the second control manner to the first control manner.

18. The electric circular saw of claim 16, further comprising a parameter detection device connected to the electric motor and the controller and configured to detect a plurality of electric motor parameters of the electric motor and output the plurality of electric motor parameters to the controller, wherein the plurality of electric motor parameters used in the first switching condition and the plurality of electric motor parameters used in the second switching condition are at least partially different.

19. The electric circular saw of claim 18, wherein the first control manner is a six-step commutation control manner, and the second control manner is a field-oriented control (FOC) manner.

20. The electric circular saw of claim 18, wherein the plurality of electric motor parameters used in the first switching condition comprise a control signal duty cycle of the electric motor, and the plurality of electric motor parameters used in the second switching condition comprise a bus current of the electric motor and/or an electric motor rotational speed.
